(19) United States
(12) Patent Application Publication
(10) Pub. No.: US 2026/0227999 A1
(43) Pub. Date: Aug. 6, 2026

(54) SYSTEM AND METHOD FOR GENERATING SEQUENCE DIAGRAMS FROM SOURCE CODE USING LARGE LANGUAGE MODELS WITH INTEGRATED FUNCTIONAL REQUIREMENTS, DATABASE INTERACTIONS, AND TICKET SYSTEM INTERACTIONS

(71) Applicant: AT&T Intellectual Property I, L.P., Atlanta, GA (US)

(72) Inventors: Sudharani Parvangada, Manalapan, NJ (US); Prafulla Verma, Holmdel, NJ (US); Rajan Anand, Manalapan, NJ (US)

(73) Assignee: AT&T Intellectual Property I, L.P., Atlanta, GA (US)

(21) Appl. No.: 19/045,680

(22) Filed: Feb. 5, 2025

(51) Int. Cl. G06F 8/73; G06F 40/40; G06N 3/0475; G06N 3/09

(52) U.S. Cl. CPC G06F 8/73; G06N 3/0475; G06N 3/09; G06F 40/40

(57) ABSTRACT

Aspects of the subject disclosure may include, for example, a system that automates the generation of sequence diagrams from source code using large language models (LLMs). Code structures are analyzed, components and interactions are identified, and high-level functional requirements are extracted. The system supports multiple programming languages and integrates database and ticket system interactions, enhancing software documentation accuracy and efficiency. Other embodiments are disclosed.

### FIELD OF THE DISCLOSURE

The subject disclosure relates to automated documentation systems.

### BACKGROUND

In the realm of software development and network management, the creation and maintenance of sequence diagrams are important for understanding system interactions and functionalities. Traditionally, this process has been manual, requiring significant time and effort from engineers to analyze and document interactions accurately. This manual approach is not only labor-intensive but also prone to human error, especially when dealing with large and complex codebases.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A and 2B are block diagrams illustrating example, non-limiting embodiment of systems functioning within the communication network of FIG. 1 in accordance with various aspects described herein.

FIG. 2C is a diagram illustrating an exemplary, non-limiting embodiment of computer source code in accordance with various aspects described herein.

FIG. 2D is a diagram illustrating an exemplary, non-limiting embodiment of a sequence diagram corresponding to the computer source code of FIG. 2C in accordance with various aspects described herein.

FIG. 2E is a diagram illustrating an exemplary, non-limiting embodiment of computer source code in accordance with various aspects described herein.

FIG. 2F is a diagram illustrating an exemplary, non-limiting embodiment of a sequence diagram corresponding to the computer source code of FIG. 2E in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for generating sequence diagrams from source code using large language models, which integrate functional requirements, database interactions, and ticket system interactions to provide comprehensive and automated documentation of software systems. Other embodiments are described in the subject disclosure.

Various embodiments described herein provide a system and method for generating sequence diagrams from source code using large language models (LLMs). The system analyzes source code to identify and extract high-level functional requirements, database interactions, and ticket system interactions, then uses this information to automatically generate detailed sequence diagrams. This process facilitates the understanding of software code, including software code that has been in service with a long lifecycle. For example, the various embodiments described herein may be useful to support a migration process of legacy network management and analysis (NMA) automation tools and enhance operational efficiency. Various embodiments may include 1) Source Code Analyzer: This module parses the source code of NMA automation tools, or any other source code, to identify key components and interactions. It leverages LLMs to understand the code's structure, logic, and functionality, irrespective of the programming languages used. 2) Functional Requirements Extractor: This component extracts high-level functional requirements from the source code and related documentation. It uses natural language processing (NLP) techniques to identify and summarize these requirements. 3) Database Interaction Module: This module identifies and extracts database interactions from the source code. It maps these interactions to the corresponding database operations and includes them in the sequence diagrams. 4) Ticket System Integrator: This component integrates various ticket system interactions into the sequence diagrams. It links code changes to specific ticketing systems, providing a comprehensive view of the development and maintenance process. 5) Diagram Generator: This module uses the extracted information to automatically generate sequence diagrams. It employs visualization tools like Mermaid.js to create clear and accurate diagrams embedded in HTML.

The automation provided by the various embodiments may significantly reduce the time and effort required to create sequence diagrams from a large codebase, while ensuring that diagrams accurately reflect the source code and interactions. Further, various embodiments may integrate functional requirements, database interactions, and ticket system interactions into a single comprehensive diagram. Various embodiments provide a scalable solution that can handle the analysis of large and complex codebases, (e.g., for hundreds, or more, NMA automation tools). The various embodiments provide operational efficiency by facilitating the smooth migration of NMA tools to new cloud-based architectures, enhancing overall operational efficiency. The various embodiments have myriad applications, including during the discovery phase of migrating NMA automation tools to new architectures. The various embodiments may be used to document, analyze, and understand the functionality and interactions of these tools, aiding in their seamless integration with new architectures and platforms.

One or more aspects of the subject disclosure include a device, comprising a processing system including a processor and a memory that stores executable instructions that, when executed by the processing system, facilitate performance of operations. The operations may include training a large language model (LLM) using a supervised training method, wherein the training includes providing the LLM with a labeled dataset comprising source code and corresponding sequence diagrams to teach the LLM to analyze and understand code structures and interactions; providing, to the LLM, source code as input to analyze and understand a structure, logic, and functionality of the source code; identifying, by the LLM, components and interactions within the source code, and providing information related to the components and the interactions to a source code analyzer for further processing; extracting, by the LLM, high-level functional requirements from the source code and related documentation, and transmitting the high-level functional requirements to a functional requirements extractor for summarization; and facilitating, by the LLM, generation of sequence diagrams by providing comprehensive interaction data to a diagram generator.

One or more aspects of the subject disclosure include a non-transitory machine-readable medium, comprising executable instructions that, when executed by a processing system including a processor, facilitate performance of operations. The operations may include providing to a large language model (LLM) source code as input to analyze and understand a structure, logic, and functionality of the source code; identifying, by the LLM, components and interactions within the source code, and providing information related to the components and the interactions to a source code analyzer for further processing; extracting, by the LLM, high-level functional requirements from the source code and related documentation, and transmitting the high-level functional requirements to a functional requirements extractor for summarization; and facilitating, by the LLM, generation of sequence diagrams by providing comprehensive interaction data to a diagram generator.

One or more aspects of the subject disclosure include a method for generating sequence diagrams from source code using a large language model (LLM), comprising: providing to an LLM, by a processing system including a processor, source code as input to analyze and understand a structure, logic, and functionality of the source code; identifying, by the LLM, components within the source code, and providing information related to the components to a source code analyzer for further processing; extracting, by the LLM, high-level functional requirements from the source code and related documentation, and transmitting the high-level functional requirements to a functional requirements extractor for summarization; and facilitating, by the LLM, the generation of sequence diagrams by providing comprehensive interaction data to a diagram generator.

Additional aspects of the subject disclosure may include utilizing prompt engineering techniques to optimize the input prompts provided to the large language model (LLM), thereby enhancing the LLM's ability to accurately identify components, interactions, and functional requirements within the source code. The operations may further comprise training the LLM using a supervised training method, wherein the training involves providing the LLM with a labeled dataset comprising source code and corresponding sequence diagrams to enhance its ability to accurately analyze and understand code structures and interactions. The LLM may also support multiple programming languages, allowing it to process source code written in different languages, and employ machine learning techniques to improve accuracy in understanding complex code structures. Additionally, the LLM may detect database interactions within the source code and communicate these interactions to a database interaction module for mapping to corresponding database operations, as well as recognize ticket system interactions and convey this information to a ticket system integrator for integration with specific ticketing systems. The generation of sequence diagrams may include the use of advanced visualization tools to create interactive sequence diagrams that allow users to explore different interaction paths.

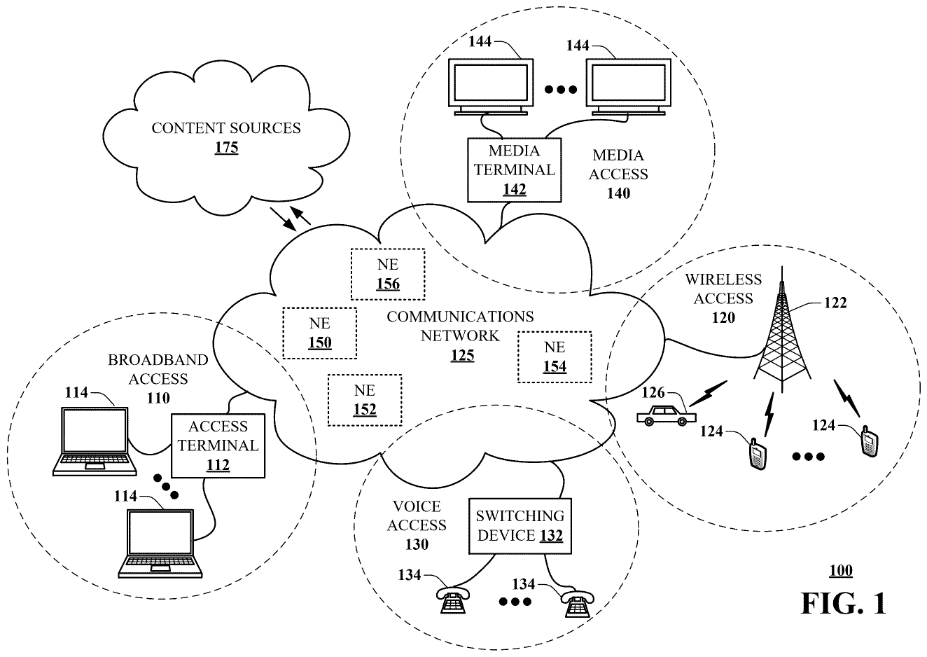

Referring now to FIG. 1, a block diagram is shown illustrating an example, non-limiting embodiment of a system 100 in accordance with various aspects described herein. For example, system 100 can facilitate in whole or in part the automated analysis of source code to identify components and interactions, the extraction of high-level functional requirements, the detection and mapping of database interactions, the integration of ticket system interactions, and the generation of detailed sequence diagrams using visualization tools. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

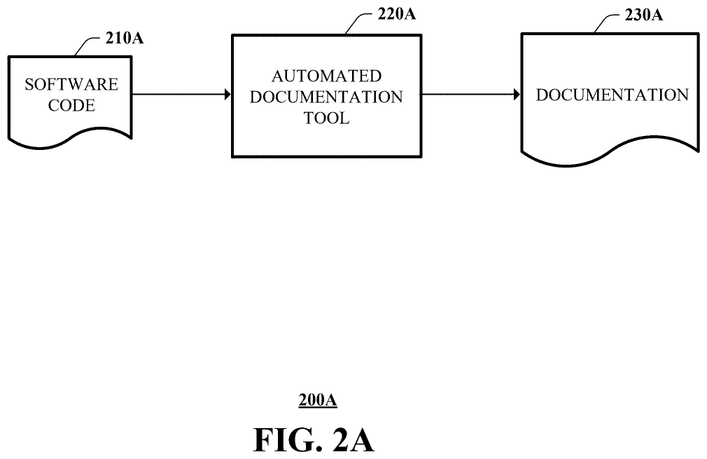

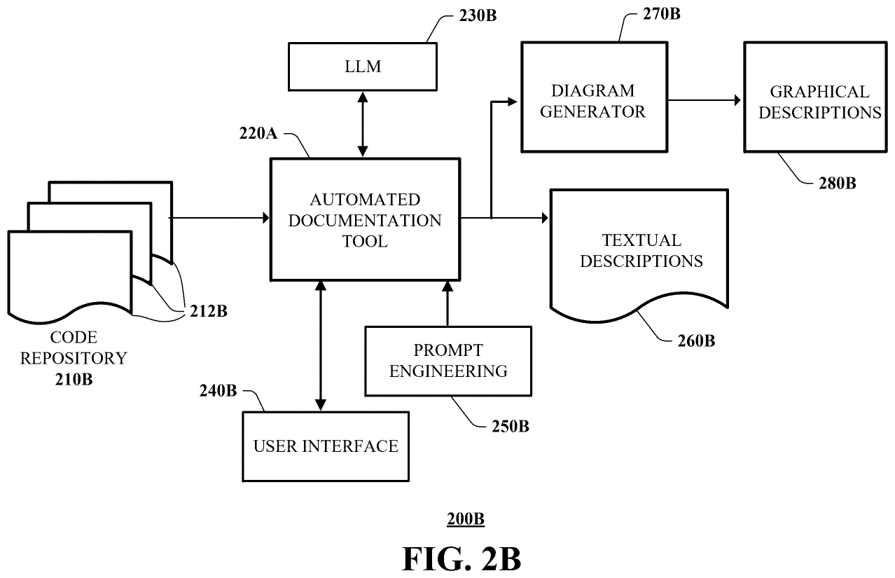

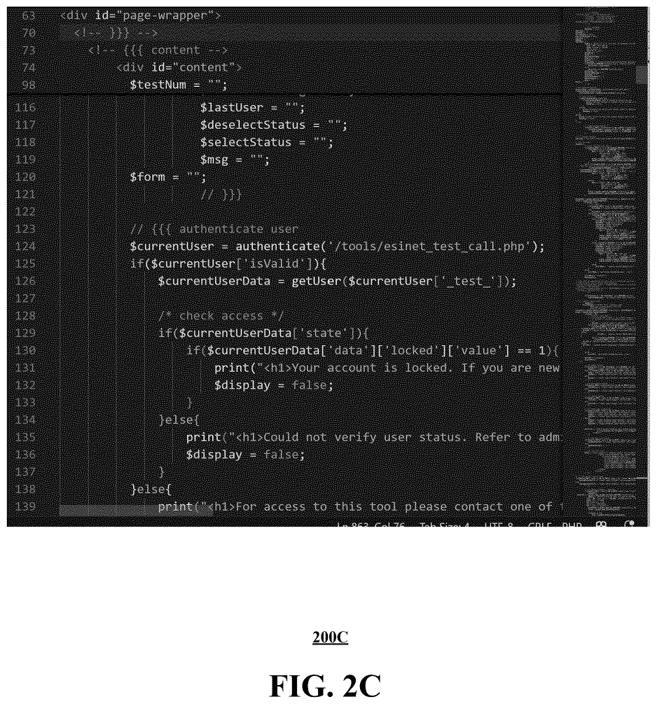

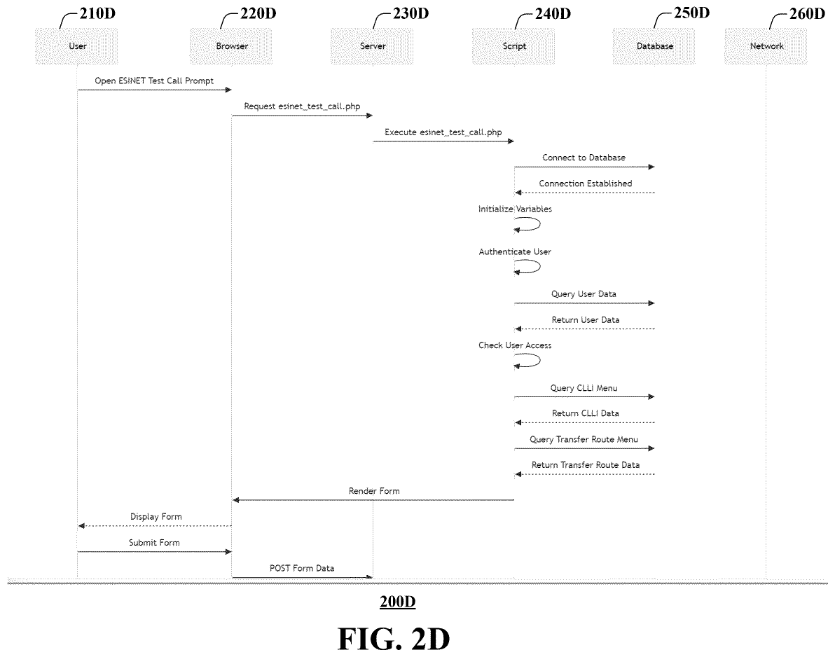

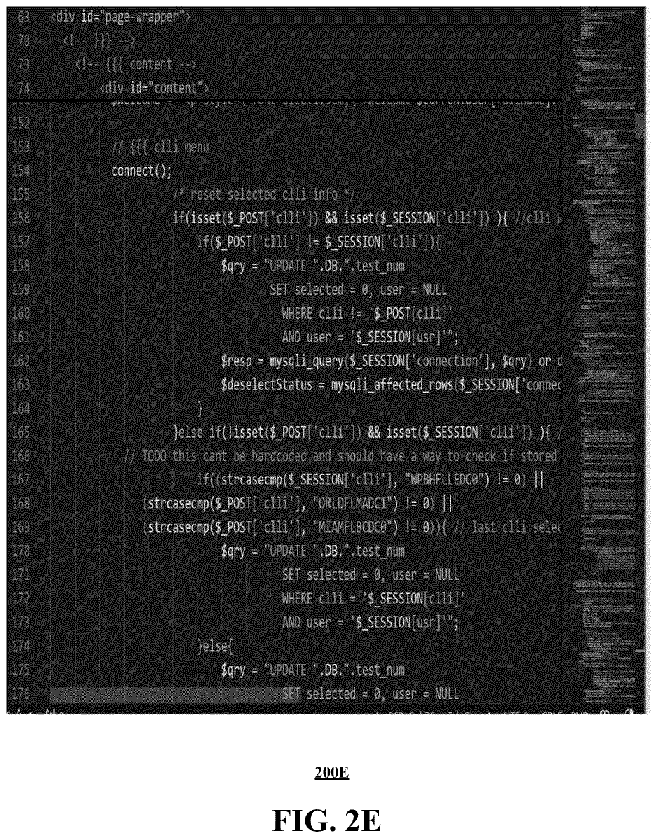

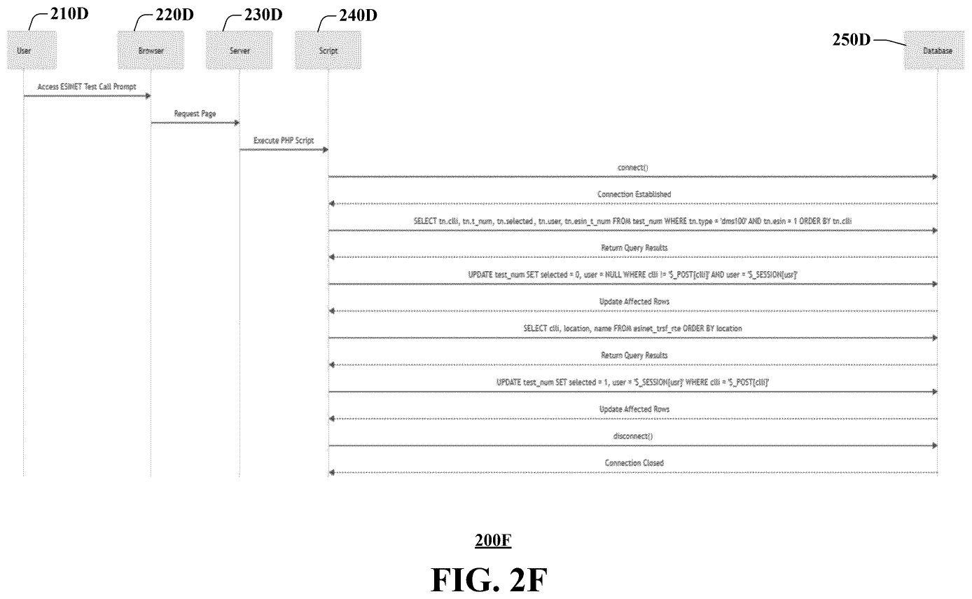

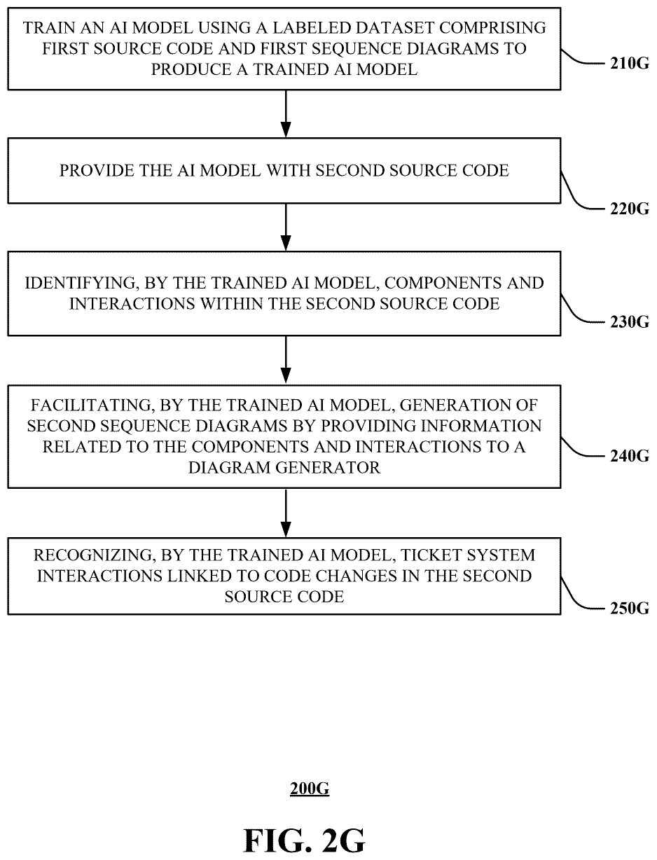

FIGS. 2A and 2B are block diagrams illustrating example, non-limiting embodiment of systems functioning within the communication network of FIG. 1 in accordance with various aspects described herein. FIG. 2A automated documentation tool 220A, software code 210A, and documentation 230A. In various embodiments, automated documentation tool 220A is designed to analyze software code 210A and generate various forms of documentation 230A, including sequence diagrams, which can provide an understanding of system interactions and functionalities.

The automated documentation tool 220A leverages advanced technologies, such as large language models (LLMs), to parse and interpret the software code 210A. It identifies key components, interactions, and functional requirements within the code, irrespective of the programming language used. This tool can be implemented in various ways, such as integrating with existing network elements (NE) like those depicted in FIG. 1, including NE 150, NE 152, NE 154, and NE 156, which are part of a communications network 125. By doing so, the tool can facilitate the documentation of complex network interactions and processes.

The software code 210A represents the input to the automated documentation tool 220A. This code can be sourced from various applications and systems, such as those providing broadband access 110, wireless access 120, voice access 130, and media access 140, as shown in FIG. 1. For example, the code could be part of the software running on access terminals 112, base stations 122, or switching devices 132.

The documentation 230A produced by the tool can take multiple forms, including detailed sequence diagrams that map out the interactions between different system components. These diagrams may then provide developers and engineers a quick understanding of the flow of data and control within the system, aiding in tasks such as system maintenance, troubleshooting, and migration to new architectures.

Examples of source code that might be processed by the automated documentation tool include scripts for managing network traffic, protocols for data transmission, or algorithms for optimizing resource allocation. The resulting documentation could include sequence diagrams illustrating the interaction between a mobile device 124 and a media terminal 142, or the data flow from a content source 175 to a media access point 140.

FIG. 2B provides a detailed overview of a system architecture for generating sequence diagrams from source code using an automated documentation tool. FIG. 2B shows the Code Repository 210B, Automated Documentation Tool 220A, LLM 230B, User Interface 240B, Prompt Engineering 250B, Textual Descriptions 260B, Diagram Generator 270B, and Graphical Descriptions 280B. Automated Documentation Tool 220A interfaces with a Code Repository 210B to access and analyze diverse programming scripts. The tool utilizes an AI model such as Large Language Model (LLM) 230B to deeply understand the code's structure, logic, and functionality. Prompt Engineering 250B optimizes the input prompts to the LLM, enhancing the accuracy of the analysis. The User Interface 240B allows users to interact with the system, inputting source code and configuring analysis parameters. The tool generates Textual Descriptions 260B and Graphical Descriptions 280B, the latter being produced by the Diagram Generator 270B, which uses advanced visualization tools to create sequence diagrams. These components work in concert to provide comprehensive documentation that aids in system maintenance, troubleshooting, and migration to new architectures.

In some embodiments, the code repository 210B serves is a storage system for the source code that is to be analyzed and documented. This repository houses the diverse programming scripts and files that the Automated Documentation Tool 220A processes. The Code Repository 210B may be implemented using various version control systems such as Git, SVN, or Mercurial, which facilitate the management of code versions and collaboration among developers. The repository is designed to accommodate code written in multiple programming languages, reflecting the diverse nature of legacy systems and modern applications. The Code Repository 210B interacts directly with the Automated Documentation Tool 220A, providing the necessary codebase for analysis and documentation generation.

Automated Documentation Tool 220A is a sophisticated system that leverages advanced technologies, including Large Language Models (LLMs), to parse and interpret the software code stored in the Code Repository 210B. This tool is responsible for analyzing the code to identify important components, interactions, and functional requirements, regardless of the programming language used. The Automated Documentation Tool 220A is designed to integrate seamlessly with existing network elements, facilitating the documentation of complex network interactions and processes. The tool employs prompt engineering techniques to optimize the input prompts provided to the LLM, enhancing the accuracy and efficiency of the analysis. The output of the tool includes various forms of documentation, such as sequence diagrams, which provide a comprehensive understanding of system interactions and functionalities.

In various embodiments, the Automated Documentation Tool 220A may have many functions. For example, the tool may train the Large Language Model (LLM) using labeled datasets. In some embodiments, this process involves supplying the LLM with a dataset that includes both source code and corresponding sequence diagrams. Through this training, the LLM can learn to discern the relationships between code structures and their functional representations, thereby improving its ability to analyze and interpret new codebases. This training phase may enhance the LLM's effectiveness in supporting the automated documentation process.

Additionally, the Automated Documentation Tool 220A may provide code from the Code Repository 210B to the trained LLM and format the output from the LLM to facilitate the generation of various types of documentation. The tool retrieves source code from the repository and employs prompt engineering techniques to optimize the input prompts for the LLM. After the LLM processes the code and returns the analyzed data, the tool formats this output into detailed textual descriptions and graphical representations, such as sequence diagrams. This formatted documentation may then be presented to users through the User Interface 240B, offering a comprehensive view of the system's functionality and interactions.

The implementation of the Automated Documentation Tool 220A can be achieved using programming languages like Python, which is well-suited for handling complex data processing tasks and interfacing with machine learning models. Python's extensive libraries and frameworks for machine learning and data analysis make it a practical choice for developing the tool's functionalities. However, the tool can also be implemented in other suitable languages, depending on the specific requirements and integration needs of the system. By leveraging these programming capabilities, the Automated Documentation Tool 220A effectively bridges the gap between raw source code and actionable documentation, streamlining the process of understanding and managing complex software systems.

The LLM 230B, which communicates with Automated Documentation Tool 220A, is responsible for the deep analysis and understanding of the source code's structure, logic, and functionality. In some embodiments, the LLM 230B is trained using a supervised training method with a labeled dataset comprising source code and corresponding sequence diagrams. This training enables the LLM 230B to accurately identify components and interactions within the code. The LLM 230B supports multiple programming languages, allowing the processing of diverse codebases effectively. The LLM 230B provides detailed information about the code's components and interactions, which is then used to generate sequence diagrams.

The LLM depicted in FIG. 2B is a sophisticated implementation of artificial intelligence (AI) designed to analyze and understand complex software code. As an AI model, the LLM is built upon advanced machine learning techniques, particularly those involving deep learning architectures. Examples of AI models that may be used to implement the LLM230B 230B include transformer-based models like GPT (Generative Pre-trained Transformer), BERT (Bidirectional Encoder Representations from Transformers), and their derivatives. These models are renowned for their ability to process and generate human-like text, making them ideal for understanding the intricacies of programming languages and software documentation.

The LLM 230B functions by leveraging a vast amount of training data, which includes source code and corresponding sequence diagrams, to learn the relationships between code structures and their functional representations. This training enables the LLM 230B to accurately identify components, interactions, and functional requirements within new codebases. The model's ability to support multiple programming languages further enhances its versatility, allowing it to process diverse codebases effectively. By employing machine learning techniques, the LLM 230B continuously improves its accuracy in understanding complex code structures, making it a powerful tool for automated documentation.

In some embodiments, the automated documentation tool 220A interfaces with the LLM 230B through a well-defined API, which facilitates seamless communication between the two components. This API allows the automated documentation tool 220A to send source code to the LLM 230B for analysis and receive detailed information about the code's components and interactions. The API acts as a bridge, ensuring that the LLM 230B can be accessed and utilized efficiently within the broader system architecture. Through this interface, the automated documentation tool 220A can leverage the LLM's capabilities to generate comprehensive documentation, including textual descriptions and graphical representations like sequence diagrams.

In practice, the integration of the LLM 230B with the automated documentation tool 220A involves a series of interactions. The automated documentation tool 220A first retrieves source code from the Code Repository and uses Prompt Engineering to optimize the input prompts for the LLM 230B. These prompts are then sent to the LLM 230B via the API, which processes the code and returns the analyzed data. The automated documentation tool 220A uses this data to produce detailed textual descriptions and graphical descriptions, which are then presented to the user through the User Interface.

The User Interface 240B provides a platform for users to interact with the Automated Documentation Tool 220A. This interface allows users to input source code, configure analysis parameters, and view the generated documentation. The User Interface 240B is designed to be intuitive and user-friendly, enabling users to navigate through the tool's features and functionalities with ease. The interface serves as the main point of interaction between the user and the underlying system, facilitating the integration of user inputs and system outputs smoothly.

The User Interface 240B can be implemented in various forms, depending on user needs and preferences. For example, the User Interface 240B may be a web-based interface accessible through a web browser, allowing users to engage with the tool from any location with internet access. This setup is beneficial for distributed teams, as it enables collaboration and access to the tool's functionalities from different geographical locations. Also for example, in some embodiments, the User Interface 240B is implemented as a text console, providing a command-line interface for users who prefer a more direct and scriptable interaction with the tool. This type of interface is often favored by developers and technical users who are comfortable with command-line operations and seek to automate interactions with the tool through scripts. In further example embodiments, the User Interface 240B may be implemented with a chat-based interface, allowing users to interact with the tool through a conversational interface, which can enhance user experience by providing a more intuitive and natural way to input commands and receive feedback.

In some embodiments, the User Interface 240B may be implemented on the same computer as the Automated Documentation Tool 220A, providing a local interface for users who are directly accessing the tool. In other embodiments, the system may be distributed, with the automated documentation tool 220A hosted on a server or in the cloud, and the User Interface 240B accessible from different users'computers. This distributed setup allows for greater flexibility and scalability, as it enables multiple users to access the tool simultaneously without the need for local installations. Regardless of the implementation, the User Interface 240B is designed to be intuitive and user-friendly, facilitating easy navigation through the tool's features and functionalities.

The Prompt Engineering 250B component is responsible for optimizing the input prompts provided to the LLM 230B. This component ensures that the prompts are structured in a way that maximizes the LLM's ability to accurately identify components, interactions, and functional requirements within the source code. Prompt Engineering 250B plays an important role in enhancing the overall performance and accuracy of the Automated Documentation Tool 220A, as the component directly influences the quality of the LLM's analysis and output.

In some embodiments, the prompt engineering component 250B is part of the automated documentation tool 220A. For example, the prompt engineering may coded in python along with other aspects of automated documentation tool 220A.

In some embodiments, the Automated Documentation Tool 220A produces output in a text format, which serves as a versatile medium for representing various types of information extracted from the source code. This text output can encompass a wide range of documentation, including sequence diagrams, database interactions, code changes, ticketing system interactions, etc. In some embodiments, the text output may serve as the final output, providing users with detailed textual descriptions that capture the essence of the system's functionality and interactions. These descriptions can be used directly for documentation purposes, offering a comprehensive view of the software's architecture and behavior.

In other embodiments, the text output functions as an intermediate step in the documentation process. For example, the text output can be fed into a graphical tool that generates visual representations, such as sequence diagrams. This approach allows for the transformation of textual data into graphical descriptions, which can be more intuitive and accessible for users who prefer visual documentation. The Diagram Generator 270B, for example, utilizes the text output to create clear and accurate sequence diagrams, providing a visual map of the interactions between different system components.

The flexibility of the text output format enables it to accommodate various documentation needs and preferences. Whether serving as a standalone documentation resource or as a precursor to graphical representations, the text output from the Automated Documentation Tool 220A plays a role in enhancing the understanding and management of complex software systems. By providing a detailed and structured representation of the system's interactions and functionalities, the text output supports a wide range of applications, from system maintenance and troubleshooting to migration and integration with new architectures.

The Textual Descriptions 260B are generated by the Automated Documentation Tool 220A as part of the documentation process. These descriptions provide detailed explanations of the identified components, interactions, and functional requirements within the source code. The Textual Descriptions 260B are designed to complement the graphical representations provided by the sequence diagrams, offering a comprehensive view of the system's functionality and interactions. They are generated using natural language processing techniques, ensuring clarity and accuracy in the documentation.

The Diagram Generator 270B is responsible for creating graphical representations of the system's interactions and functionalities based on the analysis performed by the LLM 230B and the textual output from the automated documentation tool 220A. The Diagram Generator 270B uses advanced visualization tools, such as Mermaid.js, to produce clear and accurate sequence diagrams embedded in HTML. The Diagram Generator 270B takes the textual information provided by the LLM 230B and the automated documentation tool 220A and transforms this information into visual diagrams that map out the interactions between different system components. These diagrams are useful for understanding the flow of data and control within the system, aiding in tasks such as system maintenance, troubleshooting, and migration to new architectures.

The Graphical Descriptions 280B are the visual outputs produced by the Diagram Generator 270B. In some embodiments, these descriptions may include detailed sequence diagrams that illustrate the interactions between various components within the system. The Graphical Descriptions 280B provide a visual representation of the system's functionality, complementing the Textual Descriptions 260B to offer a holistic view of the software's interactions and processes. They are designed to be interactive, allowing users to explore different interaction paths and gain a deeper understanding of the system's architecture and behavior.

FIG. 2C is a diagram illustrating an exemplary, non-limiting embodiment of computer source code in accordance with various aspects described herein. This source code 200C is written in a programming language and includes various operations such as user authentication and access checks. The code is structured to perform specific tasks, such as connecting to a database, initializing variables, and verifying user status. In some embodiments, this example source code may serve as part of a labeled dataset used to train the LLM, teaching it to understand the relationships between code structures and their functional representations. In other embodiments, the source code 200C may be an input to the Automated Documentation Tool 220A, which, through interaction with the LLM, can analyze the code and produce corresponding documentation.

FIG. 2D is a diagram illustrating an exemplary, non-limiting embodiment of a sequence diagram corresponding to the computer source code of FIG. 2C in accordance with various aspects described herein. FIG. 2D presents a sequence diagram that corresponds to the source code depicted in FIG. 2C. This diagram visually represents the interactions and processes outlined in the source code, illustrating the flow of operations from the user 210D to the browser 220D, server 230D, script 240D, database 250D, and network 260D. The sequence diagram details the steps involved in executing the script, such as opening a test call prompt, requesting and executing the script, connecting to the database, and authenticating the user. By providing a visual representation of the system's interactions, the sequence diagram aids in understanding the flow of data and control within the software.

In the context of training the LLM, the contents of FIGS. 2C and 2D together form a labeled dataset that can enhance the model's ability to analyze and interpret new codebases. The source code provides the raw data, while the sequence diagram offers a functional representation of the code's operations. When used as input to the Automated Documentation Tool 220A, the source code in FIG. 2C is processed by the LLM to generate the sequence diagram in FIG. 2D. This process exemplifies how the tool can transform complex code into accessible and actionable documentation, supporting tasks such as system maintenance, troubleshooting, and migration to new architectures.

FIG. 2E is a diagram illustrating an exemplary, non-limiting embodiment of computer source code in accordance with various aspects described herein. This code 200E includes operations related to database interactions, such as executing queries and updating records. The source code 200E is structured to perform tasks like connecting to a database, executing SQL queries, and handling user sessions. In some embodiments, this source code can be part of a labeled dataset used to train the LLM, enhancing its ability to understand and interpret code structures and their functional representations. In other embodiments, the source code 200E may be input to the Automated Documentation Tool 220A, which, through interaction with the LLM, can analyze the code and produce corresponding documentation.

FIG. 2F is a diagram illustrating an exemplary, non-limiting embodiment of a sequence diagram corresponding to the computer source code of FIG. 2E in accordance with various aspects described herein. This diagram provides a detailed visual representation of the database interactions outlined in the source code, focusing on the flow of operations between the user 210D, browser 220D, server 230D, script 240D, and database 250D. The sequence diagram details steps such as establishing a connection, executing SQL queries, and updating affected rows. This level of detail may be a result of a user query that requests the Automated Documentation Tool 220A to generate a sequence diagram emphasizing database interactions. By offering a visual representation of these interactions, the sequence diagram aids in understanding the flow of data and control within the software.

Together, FIGS. 2E and 2F form a comprehensive dataset that can be used to train the LLM, enhancing its ability to analyze and interpret new codebases. The source code provides the raw data, while the sequence diagram offers a functional representation of the code's operations. When used as input to the Automated Documentation Tool, the source code in FIG. 2E is processed by the LLM to generate the sequence diagram in FIG. 2F. This process exemplifies how the tool can transform complex code into accessible and actionable documentation, supporting tasks such as system maintenance, troubleshooting, and migration to new architectures.

FIG. 2G depicts an illustrative embodiment of a method in accordance with various aspects described herein. The method 200G depicted in FIG. 2G illustrates a comprehensive approach for generating sequence diagrams from source code using a large language model (LLM). This method involves several components and steps that work together to automate the documentation process, ensuring accuracy and efficiency in understanding complex software systems.

At block 210G, the method includes training an AI model (e.g., LLM 230B) using a labeled dataset comprising first source code and first sequence diagrams to produce a trained AI model. In some embodiments, this training can be conducted using supervised learning, where the AI model is provided with labeled datasets that include both source code and corresponding sequence diagrams. For example, FIG. 2C and FIG. 2D together form a labeled dataset where the source code in FIG. 2C is paired with the sequence diagram in FIG. 2D, illustrating the flow of operations such as user authentication and database interactions. This pairing helps the AI model learn the relationships between code structures and their functional representations.

In contrast, unsupervised learning does not rely on labeled datasets. Instead, the AI model identifies patterns and structures within the data on its own. While unsupervised learning may not be as efficient in the context of generating sequence diagrams, it can be used to discover underlying patterns in large codebases without predefined labels. For example, the AI model might analyze the source code in FIG. 2E to identify common database interaction patterns, which could then be used to generate a sequence diagram similar to FIG. 2F, focusing on database operations.

The training process may also involve concepts such as prompt engineering, where the input prompts provided to the LLM are optimized to enhance its ability to accurately identify components, interactions, and functional requirements within the source code. This approach ensures that the AI model is well-equipped to handle diverse programming languages and complex code interactions, ultimately improving its performance in generating accurate and comprehensive sequence diagrams.

At block 220G, the method involves providing the AI model with second source code. In some embodiments, this step may include a user querying the Automated Documentation Tool 220A through the User Interface 240B, as depicted in FIG. 2B. The user may specify particular requirements or areas of interest, such as database interactions or specific modules within the codebase. For example, a user might request an analysis of the source code related to user authentication, as shown in FIG. 2C, or database operations, as illustrated in FIG. 2E.

Upon receiving the query, the Automated Documentation Tool 220A retrieves the relevant source code from the Code Repository 210B. This retrieval process is facilitated by the tool's ability to access and manage diverse programming scripts stored within the repository. For example, if a user queries for code related to database interactions, the tool may access the source code depicted in FIG. 2E, which includes SQL queries and database connection operations.

Once the source code is retrieved, it is provided to the LLM for analysis. The LLM applies its learned capabilities to understand the structure, logic, and functionality of the code, preparing it for further processing and documentation generation. This interaction between the user query, the Automated Documentation Tool, and the LLM exemplifies how the system can dynamically respond to user inputs and generate tailored documentation outputs, such as the sequence diagrams shown in FIGS. 2D and 2F.

At block 230G, the method involves identifying, by the trained AI model, components and interactions within the second source code. In some embodiments, this identification process in which the AI model applies its learned capabilities to dissect the source code and recognize various elements and their interconnections. For example, the AI model may identify functions, classes, and data flows within the code, as well as interactions with external systems such as databases or ticketing systems.

In some embodiments, the AI model's ability to identify components and interactions is enhanced by its training on labeled datasets, as described in block 210G. This training allows the model to understand complex code structures and their functional representations, enabling it to accurately detect key elements within the second source code. For instance, the model might recognize database interaction patterns similar to those depicted in FIG. 2E, or it might identify user authentication processes akin to those shown in FIG. 2C.

In some embodiments, the AI model may also detect interactions that are not immediately apparent, such as indirect dependencies or asynchronous processes. This capability may be valuable for analyzing large and complex codebases, where manual identification of components and interactions would be time-consuming and error-prone. By automating this process, the AI model provides a comprehensive understanding of the code's structure and functionality, laying the groundwork for subsequent steps in the documentation process, such as generating sequence diagrams in block 240G.

At block 240G, the method involves facilitating, by the trained AI model, the generation of second sequence diagrams by providing information related to the components and interactions to a diagram generator. In some embodiments, this facilitation process involves the AI model transmitting detailed interaction data to a diagram generator, which then uses this information to create visual representations of the code's functionality. For example, the diagram generator may utilize advanced visualization tools to produce sequence diagrams that map out the interactions between different system components, similar to those depicted in FIGS. 2D and 2F.

The sequence diagrams generated at this stage provide a visual representation of the system's interactions, illustrating the flow of data and control within the software. This visual documentation may be useful for developers and engineers, as it offers an intuitive and accessible way to understand complex code structures and their functional relationships. For example, the sequence diagram in FIG. 2D visually represents the interactions outlined in the source code of FIG. 2C, detailing steps such as user authentication and database queries.

At block 250G, the AI model recognizes ticket system interactions linked to code changes in the second source code. In some embodiments, this recognition involves detecting modifications in the code that correspond to specific ticketing system entries. For example, the AI model may identify code changes associated with bug fixes or feature requests, linking them to relevant tickets for comprehensive documentation.

Overall, the method 200G provides a scalable and efficient solution for generating sequence diagrams from source code, leveraging the capabilities of a trained AI model to automate the documentation process. By integrating functional requirements, database interactions, and ticket system interactions into a single comprehensive diagram, the method enhances operational efficiency and supports the seamless migration of software systems to modern architectures.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

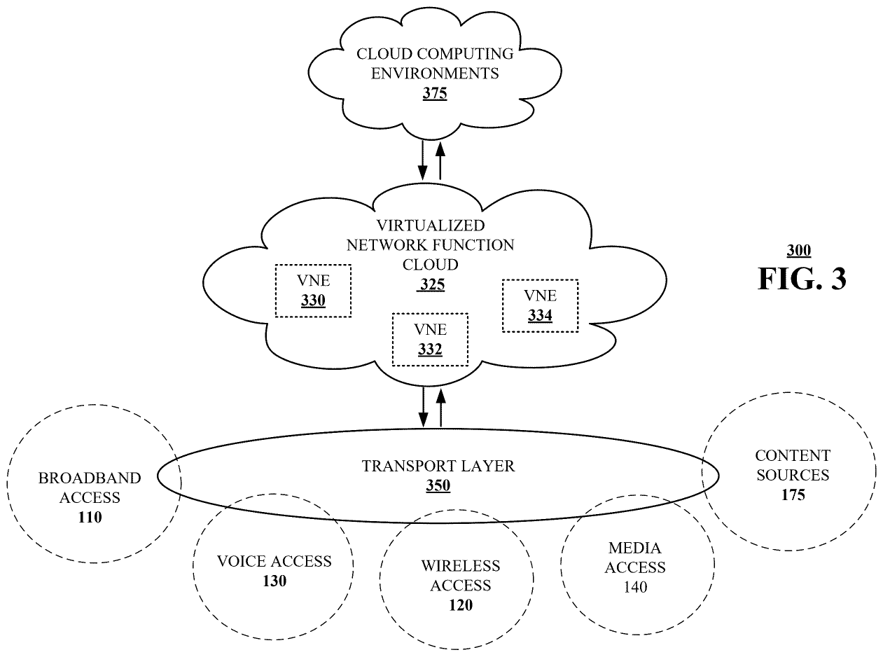

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part the processing and analysis of source code using large language models to identify key components and interactions, the extraction and integration of functional requirements and database interactions, and the generation of comprehensive sequence diagrams that accurately reflect system functionalities and interactions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

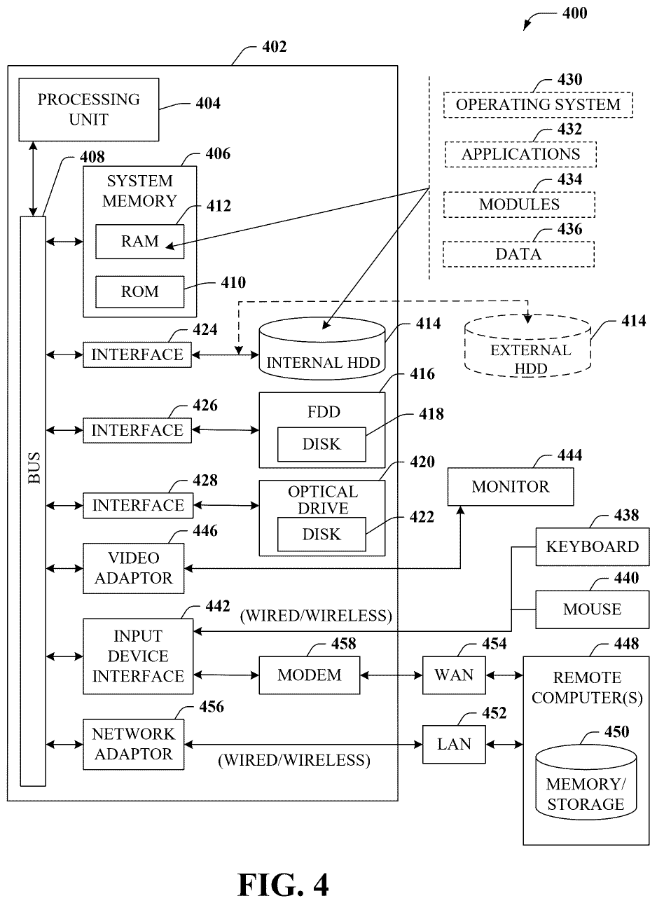

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the execution of operations for analyzing source code using a large language model, identifying components and interactions, extracting high-level functional requirements, and generating sequence diagrams that integrate database and ticket system interactions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

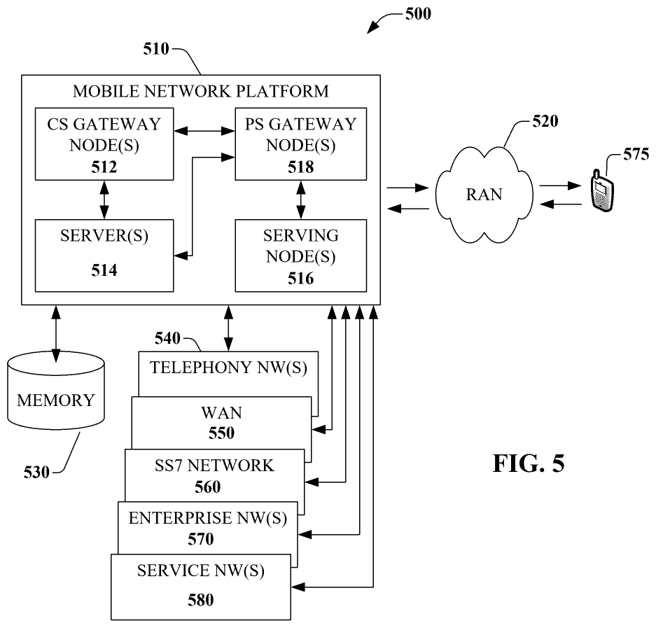

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part the automated generation of sequence diagrams by analyzing source code with a large language model, identifying and mapping database interactions, extracting high-level functional requirements, and integrating ticket system interactions to provide comprehensive documentation of software systems. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

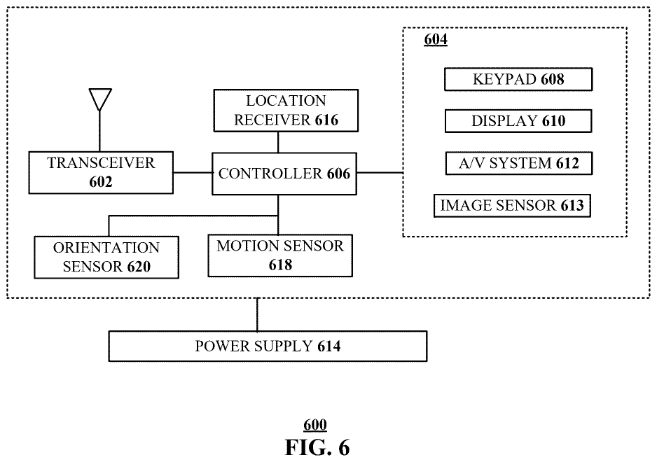

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part the analysis of source code using a large language model to identify components and interactions, the extraction of high-level functional requirements, and the generation of sequence diagrams that incorporate database and ticket system interactions, providing a comprehensive view of software system functionalities.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
training a large language model (LLM) using a supervised training method, wherein the training includes providing the LLM with a labeled dataset comprising first source code and first sequence diagrams to teach the LLM to analyze and understand relationships between the first source code and the first sequence diagrams;
providing, to the LLM, second source code as input;
identifying, by the LLM, components and interactions within the second source code;
facilitating, by the LLM, generation of second sequence diagrams by providing information related to the components and interactions to a diagram generator.

2. The device of claim 1, wherein the operations further comprise utilizing prompt engineering techniques to optimize input prompts provided to the LLM.

3. The device of claim 1, wherein the identifying the components and interactions comprises detecting, by the LLM, database interactions within the second source code.

4. The device of claim 3, wherein the facilitating the generation of the second sequence diagrams comprises providing information related to the database interactions to the diagram generator.

5. The device of claim 1, further comprising:
recognizing, by the LLM, ticket system interactions linked to code changes, and conveying the ticket system interactions to a ticket system integrator for integration with specific ticketing systems.

6. The device of claim 1, wherein the facilitating the generation of the second sequence diagrams comprises embedding the information related to the components and interactions in HTML.

7. The device of claim 1, wherein the LLM includes support for multiple programming languages, allowing the LLM to process the second source code written in different languages.

8. A non-transitory machine-readable medium, comprising executable instructions that, when executed by a processing system including a processor, facilitate performance of operations, the operations comprising:
providing to a large language model (LLM) source code as input to analyze and understand a structure, logic, and functionality of the source code;
identifying, by the LLM, high level functional requirements of the source code; and
facilitating, by the LLM, generation of sequence diagrams by providing the high level functional requirements to a diagram generator.

9. The non-transitory machine-readable medium of claim 8, wherein the identifying the high level functional requirements comprises detecting, by the LLM, database interactions within the source code.

10. The non-transitory machine-readable medium of claim 9, wherein the facilitating the generation of the sequence diagrams comprises providing information related to the database interactions to the diagram generator.

11. The non-transitory machine-readable medium of claim 8, further comprising:
recognizing, by the LLM, ticket system interactions linked to code changes, and conveying the ticket system interactions to a ticket system integrator for integration with specific ticketing systems.

12. The non-transitory machine-readable medium of claim 8, wherein the facilitating the generation of the sequence diagrams comprises embedding the high level functional requirements in HTML.

13. The non-transitory machine-readable medium of claim 8, wherein the LLM includes support for multiple programming languages, allowing the LLM to process the source code written in different languages.

14. The non-transitory machine-readable medium of claim 8, wherein the LLM employs machine learning techniques to improve accuracy in understanding complex code structures.

15. A method, comprising:
providing to an LLM, by a processing system including a processor, source code as input to analyze and understand a structure, logic, and functionality of the source code;
extracting, by the LLM, high-level functional requirements from the source code; and
facilitating, by the LLM, the generation of sequence diagrams by providing the high-level functional requirements to a diagram generator.

16. The method of claim 15, wherein the extracting the high-level functional requirements includes use of a natural language processing (NLP) module to refine the high-level functional requirements from both code comments and external documentation.

17. The method of claim 15, wherein the generation of sequence diagrams includes use of visualization tools to create interactive sequence diagrams that allow users to explore different interaction paths.

18. The method of claim 15, further comprising training the LLM using a dataset comprising annotated source code and corresponding sequence diagrams.

19. The method of claim 15, further comprising:
detecting, by the LLM, database interactions within the source code, and communicating the database interactions to a database interaction module for mapping to corresponding database operations.

20. The method of claim 15, further comprising:
recognizing, by the LLM, ticket system interactions linked to code changes, and conveying the ticket system interactions to a ticket system integrator for integration with specific ticketing systems.
